(19) United States
(12) Patent Application Publication
(10) Pub. No.: US 2026/0058513 A1
(43) Pub. Date: Feb. 26, 2026

(54) STATOR ELEMENT OF AN ELECTRIC MACHINE FOR AN AIRCRAFT

(71) Applicant: SAFRAN, Paris (FR)

(72) Inventors: Sabrina Siham AYAT, MOISSY-CRAMAYEL (FR); Sulivan KUTTLER, MOISSY-CRAMAYEL (FR); Benjamin DAGUSE, MOISSY-CRAMAYEL (FR)

(73) Assignee: SAFRAN, Paris (FR)

(21) Appl. No.: 19/104,598

(22) PCT Filed: Aug. 17, 2023
(86) PCT No.: PCT/FR2023/051276

§ 371 Date: Feb. 18, 2025

(30) Foreign Application Priority Data
Aug. 19, 2022 (FR) 2208388

(51) Int. Cl. H02K 3/24; B64D 27/34

(52) U.S. Cl. CPC H02K 3/24; B64D 27/34

(57) ABSTRACT

A stator element an electrical conductor that is elongate and hollow in order to define a flow channel that allows a coolant to flow from one end of the conductor to the other. The stator element further includes a conductor designed to pass an electric current and a connection element located at one of the ends of the conductor. The connection element includes a fluid connection terminal designed to allow coolant to enter the channel or to exit from the channel, and an electrical connection terminal designed to electrically connect the conductor. The conductor and the connection element are formed of a single unitary part.

### TECHNICAL FIELD OF THE INVENTION

The present invention relates to a stator element of an electric machine for an aircraft, as well as to an electric machine comprising such an element, and to an aircraft comprising such an electric machine.

### TECHNICAL BACKGROUND

The development of “more electric” airplanes and the subsequent need for high-power, compact electric machines require that thermal considerations be taken into account in the design phase of electric machines. In fact, the current densities can reach very high values for power demands of the order of a hundred kW or even MW.

In this context, the stator windings are often the main source of losses in electric machines. The maximum temperature of the windings (dictated by the maximum temperature of the conductors' insulators) limits the current density and thus the torque density of the machine. The resistivity of the conductors and the subsequent Joule losses increase with temperature, which can reduce the efficiency of the machine. It is therefore crucial to improve heat transfer properties as close as possible to the windings.

The commonly used solutions for cooling electric machines include natural convection, forced air convection and forced liquid convection.

The natural convection is the simplest solution, with most of the heat dissipated through the casing of the machine. Fins are frequently added to the casing to increase the convection surface area, and therefore heat dissipation.

Forced air convection cooling systems generally include a fan, which increases the overall heat exchange coefficient but has disadvantages in terms of reliability and overall weight reduction. The liquid forced convection cooling systems of the “water jacket” type provide good heat extraction, compared with air cooling methods.

One of the limitations of the cooling solutions described above is that the heat is dissipated via the casing of the electric machine, located at its periphery. The heat produced within the windings must therefore pass through several areas of the machine (notch paper, magnetic yoke, etc.) before being evacuated.

New solutions, known as direct winding cooling, are currently being proposed. These solutions allow the heat generated by the windings to be dissipated at its source. For example, a fluid can circulate inside a hollow conductor, or inside a notch that is immersed or with oil circulation.

The invention falls into the first category.

For example, it is known to use a stator element of an electric machine, comprising:
an electrical conductor that is elongate and hollow in order to define a flow channel of a coolant from one end to the other of the conductor, the conductor being designed to pass an electrical current; and
a connection element located at one of the ends of the conductor, comprising:
   a fluid connection terminal designed to allow the coolant to enter the channel or else the coolant to exit from the channel, and
   an electrical connection terminal designed to electrically connect the conductor.

In the state of the art, the connection element is attached to the end of the conductor. This requires soldering or brazing between the two, while generally respecting a temperature limit for the conductor (around 180° C. for enamelled conductors). In addition, it is necessary to ensure that the assembly is watertight, which can be difficult in particular because of the previous constraint not to overheat the conductor and the small size of the conductors and their internal conduit (e.g. 2 mm×3 mm with 0.3 mm internal conduit).

It may therefore be desirable to provide a stator element for an electric machine which avoids at least some of the above-mentioned problems and constraints.

### SUMMARY OF THE INVENTION

A stator element of an electric machine is therefore proposed, comprising:
an electrical conductor that is elongate and hollow in order to define a flow channel of a coolant from one end to the other of the conductor, the conductor being designed to pass an electrical current; and
a connection element located at one of the ends of the conductor, comprising:
   a fluid connection terminal designed to allow the coolant to enter the channel or else the coolant to exit from the channel, and
   an electrical connection terminal designed to electrically connect the conductor;
      characterised in that the conductor and the connection element are formed from a single unitary part.

The invention may also comprise one or more of the following optional characteristics, in any technically possible combination.

Optionally, the unitary part is made by one of the following methods: additive manufacturing, wire drawing, machining and moulding.

Optionally, the unitary part is made of copper, aluminium or an alloy of one of the two preceding materials.

Also optionally, the flow channel has an internal diameter and the fluid connection element has an internal diameter greater than the internal diameter of the flow channel, as well as a constriction between the diameter of the connection element and the diameter of the flow channel.

Also optionally, the constriction is gradual.

Also optionally, the constriction has rounded edges.

Also optionally, the electrical connection terminal comprises an electrical connection hole, for example for screwing, for example provided on a tab.

Also optionally, the electrical connection terminal comprises a threaded rod, for example provided on a tab.

Also optionally, the fluid connection terminal comprises a male or female end piece, for example, for connection to a flexible hose.

Also optionally, the stator element further comprises another connection element located at another end of the conductor, comprising:
a fluid connection terminal for the coolant to enter the flow channel or else the coolant to exit the flow channel, and
an electrical connection terminal for electrically connecting the conductor;
   the conductor and the two connection elements being formed from a single unitary part.

Also proposed is an electric machine comprising:
a rotor; and
a stator for driving the rotor, the stator comprising a stator element in accordance with the invention.

Also proposed is an aircraft comprising an electric machine in accordance with the invention.

### BRIEF DESCRIPTION OF THE FIGURES

The invention will be better understood with the aid of the following description, given only by way of example and made with reference to the attached drawings wherein:

FIG. 1 is a three-dimensional view of an example of an electric machine in which the invention can be implemented,

FIG. 2 is a three-dimensional view of an example of a stator element according to the invention, which can be used in the electric machine of FIG. 1,

FIG. 3 is a cross-sectional view of an example of a connection element that may form part of the stator element of FIG. 2,

FIG. 4 is a cross-sectional view of a first alternative of a coolant conduit provided in the connection element of FIG. 3,

FIG. 5 is a cross-sectional view of a second alternative coolant conduit provided in the connection element of FIG. 3,

FIG. 6 is a three-dimensional view of another example of a stator element according to the invention, which can be used in the electric machine of FIG. 1,

FIG. 7 is a three-dimensional view of an example of a hollow electrical conductor that can be used in the stator element of FIG. 2,

FIG. 8 is a cross-sectional view of the hollow electrical conductor in FIG. 7,

FIG. 9 is a three-dimensional view of an alternative connection element, and

FIG. 10 is a three-dimensional transparent view of the variant shown in FIG. 9.

### DETAILED DESCRIPTION OF THE INVENTION

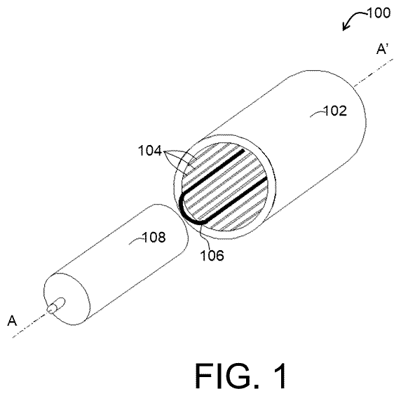

With reference to FIG. 1, an example of an electric machine 100 in which the invention can be implemented will now be described.

The electric machine 100 firstly comprises a stator 102 in the form of a cylinder centred on an axis of rotation AA′.

The stator 102 comprises, for example, longitudinal slots 104 and windings 106 (only one is shown in FIG. 1 for clarity) with longitudinal portions inserted in the notches 104. The windings 106 can be distributed or concentric.

The electric machine 100 further comprises a rotor 108 extending into an interior space of the stator 102 (the rotor 108 is shown outside the stator 102 in FIG. 1).

Each winding 106 is designed to have an electrical current flowing through it, in particular to generate a magnetic field for driving the rotor 108 about the axis of rotation AA′ when the electric machine 100 is operating as a motor.

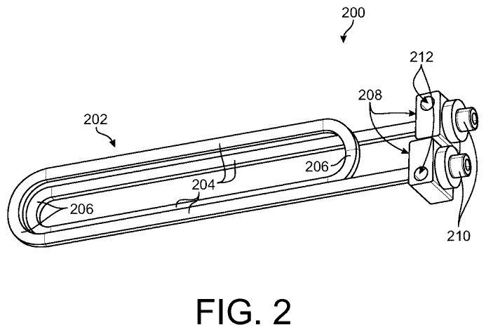

With reference to FIG. 2, a stator element 200 according to the invention, which can be used in the machine shown in FIG. 1, will now be described.

In general, a stator element according to the invention can form all or part of a winding 106. In the example shown, the stator element 200 forms a winding 106.

The stator element 200 firstly comprises an electrical conductor 202 that is elongate and hollow in order to define a flow channel of a coolant (liquid, e.g. water, glycol water, silicone oil, bearing lubrication fluid (such as BP oil 380), or gaseous, e.g. air, nitrogen, helium) from one end to the other of the conductor 202. For example, the conductor 202 has several longitudinal portions 204, for example designed to be inserted in the notches 104, connected by curved portions 206. The conductor 202 thus forms one or more turns (two in the example shown).

The stator element 200 further comprises, on at least one of the ends of the conductor 202, a connection element 208. For example, as in FIG. 2, a connection element 208 is provided at each end of the conductor 202.

The connection element 208 firstly comprises a fluid connection terminal 210 designed to allow the coolant to enter the channel or else the coolant to exit from the channel. The fluid connection terminal 210 is for example in the form of an end piece, for example cylindrical, for example male to be inserted for example into a flexible hose of the cooling system, for example hydraulic or pneumatic, or female for example so that the flexible hose is inserted into the end piece.

In general, the fluid connection terminal 210 can be threaded, for example, to a liquid or gas standard (for example, BSP (British Standard Pipe thread), NPT (National Pipe Tapered thread), etc.) or other thread (for example, a quick coupling). The fluid connection 210 can be male or female.

The connection element 208 also comprises an electrical connection terminal 212 designed to electrically connect the conductor 202. For example, the electrical connection terminal 212 comprises a hole into which a lug is intended to be screwed (as in the example in FIG. 2).

Generally speaking, the electrical connection terminal can be standard (e.g. a lug) or other (e.g. a military connector). Other terminals may be provided on the body 302, for example connections required for electrical measurements (e.g. voltage). If the hole in the connection terminal 212 is through-hole, it is possible to connect the lug to carry current to one end of the hole and place one or more sensors (e.g. voltage sensors) at the other end of the hole. When the hole in the connection terminal 212 is not a through hole, the lug and the sensor(s) can be connected to the only open end of the hole.

According to the invention, the conductor 202 and the connection element(s) 208 are formed from a single unitary part. This allows to obtain:
a simpler assembly (lower costs and fewer assembly steps) and reduced risk of obstruction: in fact, when the conductor is soldered or brazed to the connecting element, tin (or other material) could seep through and obstruct the passage of the fluid;
a reduction in the electrical resistance between the connection element 208 and the conductor 202;
a better seal between the connection element 208 and the conductor 202; and
a reduction in the risk of damage to the enamel of the conductor 202: in fact, during soldering/brazing between the conductor and the connection element, the parts are heated, so that if the temperature becomes too high (e.g. over 180° C.), the enamel of the conductor can be damaged.

For example, this single unitary part can be produced by additive manufacturing. However, for example, depending on the geometry of the conductor 202 (and in particular its length), other manufacturing methods may be envisaged, such as wire drawing, machining or moulding. The manufacturing methods allowing to produce a curved 202 conductor (rather than a straight one) allow to limit the risk of obstructions, since when bending the straight conductor, the deformation of the passage cross-section of the fluid can, in some cases (e.g. small/short radius of curvature), be poorly controlled.

The single unitary part can be made of copper, aluminium or an alloy of one of the above two materials.

The flow channel can have a round, rectangular, diamond-shaped or other cross-section. The outer shape of the conductor 202 may differ from that of the cross-section of the flow channel: for example, the cross-section of the flow channel may be round inside a conductor 202 with a rectangular external cross-section.

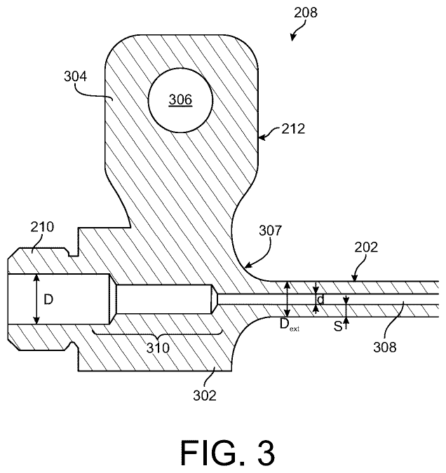

With reference to FIG. 3, an example of a connection element 208 will now be described in more detail.

The connection element 208 has a body 302 at the end of the electrical conductor 202 and carrying the terminals 210, 212. In the example shown, the electrical connection terminal 212 is in the form of a tab 304 with a screw hole 306, for example to a busbar.

Preferably, a chamfer 307 is provided between the body 302 and the electrical conductor 202, in order to mechanically reinforce the connection between the body 302 and the electrical conductor 202.

The routing channel, designated by reference 308, has an internal diameter d, while the hydraulic connection terminal 210 has an internal diameter D that is generally larger than that of the routing channel 304.

A constriction 310 is therefore provided in the body 302 between the diameter D and diameter d.

Preferably, the constriction 310 is gradual, in order to reduce the pressure drops. In fact, according to Barlow's law, the maximum pressure a pipe can withstand depends on its dimensions and material, so that maximum pressure drop are given by:

$$P = \frac{2 σ S}{{D}_{ext}} \qquad [ Math . 1 ]$$

where P is the pressure drop [Pa], σ is the elastic limit [Pa], S is the wall thickness of the conductor 202 [m], Dₑₓₜ is the outer diameter of the conductor 202.

In the example shown in FIG. 3, the constriction 310 is stepwise with straight slopes between the steps. As a result, it is easy to machine, since drills of decreasing diameter can be used.

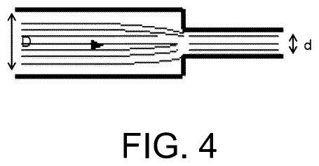

With reference to FIG. 4, the constriction 310 could be abrupt. In this case, the pressure drops are given by:

$$P = 0 , 25 ρ ( 1 - \frac{{D}^{2}}{{d}^{2}} ) {V}^{2} \qquad [ Math . 2 ]$$

where P is the pressure drop [Pa], p is the mass density of the coolant [kg/m³] and V is the average speed of the fluid after constriction [m/s].

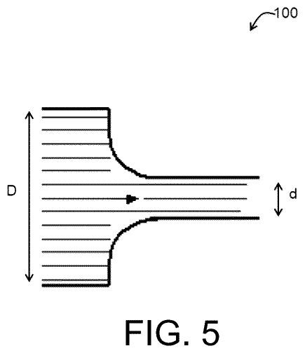

With reference to FIG. 5, the constriction 310 could be rounded. In this case, the pressure drops are given by:

$$P = 0 , 025 ρ {V}^{2} \qquad [ Math . 3 ]$$

where P is the pressure drop [Pa], ρ is the mass density of the coolant [kg/m³] and Vis the average speed of the fluid after constriction [m/s].

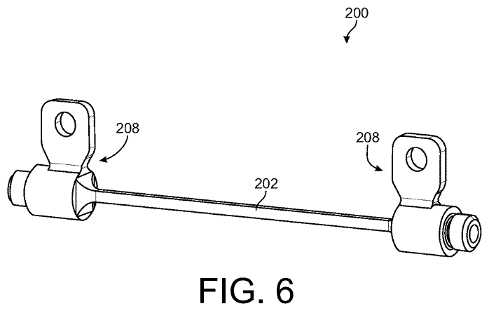

With reference to FIG. 6, the conductor 202 can also be straight.

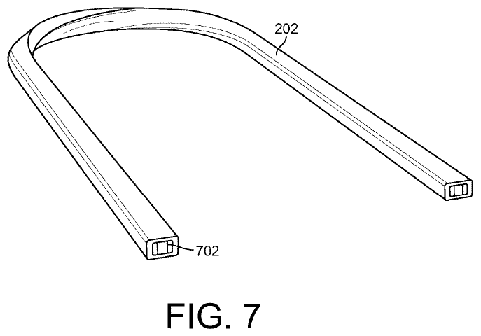

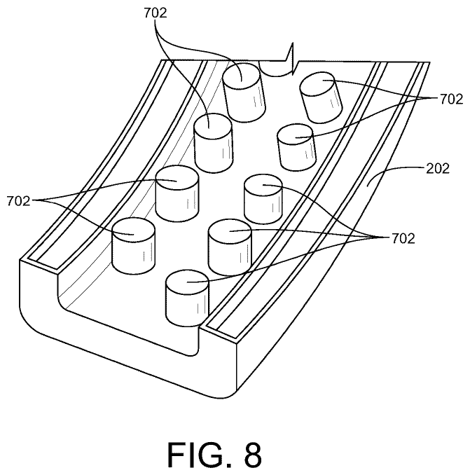

With reference to FIGS. 7 and 8, in particular when the stator element 200 is produced by additive manufacturing, the conductor 202 may further comprise fins or pins 702 extending into the conveying pipe to improve heat transfer between the fluid and the conductor 202.

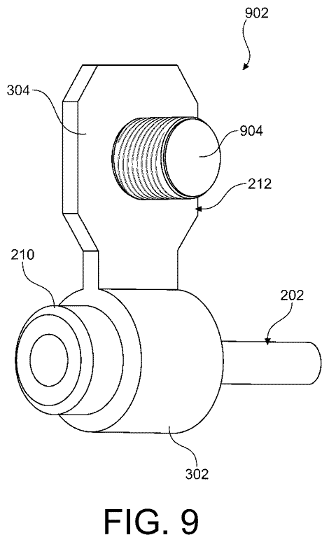

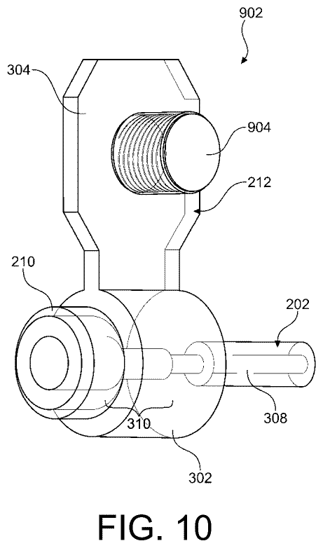

FIG. 9 and FIG. 10 illustrate a variant of the connection element 208 of the previous figures, this variant bearing the reference 902.

The connection element 902 is identical to the connection element 208, except that the screw hole 306 is replaced by a threaded rod 904 projecting from the tab 304. The threaded rod 904 is designed, for example, to be inserted into a hole in a busbar and tightened by a bolt or equivalent.

In conclusion, it should be noted that the invention is not limited to the embodiments described above. In fact, it will appear to the person skilled in the art that various modifications can be made to the above-described embodiments, in the light of the teaching just disclosed.

In the foregoing detailed presentation of the invention, the terms used should not be interpreted as limiting the invention to the embodiments exposed in the present description, but should be interpreted to include all equivalents the anticipation of which is within the reach of the person skilled in the art by applying his general knowledge to the implementation of the teaching just disclosed.

1. A stator element of an electric machine for an aircraft, the stator element comprising:
an electrical conductor that is elongate and hollow in order to define a flow channel configured to have a coolant to flow from a first end to a second end of the conductor, the conductor being designed to pass an electrical current; and
a first connection element located at one of the first and second ends of the conductor, the first connection element comprising:
a first fluid connection terminal designed to allow the coolant to enter the channel or to exit from the channel, and
a first electrical connection terminal designed to electrically connect the conductor;
wherein the conductor and the connection element are formed from a single unitary part.

2. The stator element according to claim 1, wherein the unitary part is made by one additive manufacturing, wire drawing, machining, and molding.

3. The stator element according to claim 1, wherein the unitary part is made of copper, aluminum, a copper alloy, or an aluminum alloy.

4. The stator element according to claim 1, wherein the flow channel has an internal diameter and the fluid connection element has an internal diameter greater than the internal diameter of the flow channel, as well as a constriction between the diameter of the connection element and the diameter of the flow channel.

5. The stator element according to claim 4, wherein the constriction is gradual.

6. The stator element according to claim 5, wherein the constriction has rounded edges.

7. The stator element according to claim 1, wherein the first electrical connection terminal comprises an electrical connection hole.

8. The stator element according to claim 1, wherein the first electrical connection terminal comprises a threaded rod.

9. The stator element according to claim 1, wherein the first fluid connection terminal comprises a male or female end piece.

10. The stator element according to claim 1, further comprising a second connection element located at another end of the conductor, comprising:
a second fluid connection terminal for the coolant to enter the flow channel or to exit from the flow channel, and
a second electrical connection terminal for electrically connecting the conductor;
the conductor and the first and second connection elements being formed from a single unitary part.

11. An electric machine comprising:
a rotor; and
a stator configured to drive the rotor, the stator comprising the stator element according to claim 1.

12. An aircraft comprising then electric machine according to claim 11.
